(19) United States
(12) Patent Application Publication
(10) Pub. No.: US 2017/0018822 A1
(43) Pub. Date: Jan. 19, 2017

(54) LITHIUM ION BATTERY AND ELECTRONIC DEVICE USING SAME

(71) Applicant: KURITA WATER INDUSTRIES LTD., Tokyo (JP)

(72) Inventor: Mitsuru NOZUE, Tokyo (JP)

(21) Appl. No.: 15/124,509

(22) PCT Filed: Jun. 11, 2014
(86) PCT No.: PCT/JP2014/065439

§ 371 Date: Sep. 8, 2016

(30) Foreign Application Priority Data
Mar. 12, 2014 (JP) 2014-048976

(51) Int. Cl. H01M 10/52; H01M 10/058; H01M 10/0525

(52) U.S. Cl. CPC H01M 10/52; H01M 10/0525; H01M 10/058

(57) ABSTRACT

A nonaqueous electrolytic solution lithium ion battery comprises a positive electrode terminal, a negative electrode terminal and a battery case, and an electrode body is contained within the battery case. The electrode body comprises a positive electrode collector, an electrode plate for positive electrodes, a negative electrode collector and an electrode plate for negative electrodes. The electrode plate for positive electrodes and the electrode plate for negative electrodes are laminated with a separator being interposed therebetween. A CO and CO₂ adsorbent is disposed within the battery case of this lithium ion battery. A lithium ion battery according to the present invention is capable of reducing deformation of an airtight container accompanying increase of the internal pressure due to a gas component such as CO or CO₂, which is generated within the battery at the time of abnormality or during a long period of use.

### TECHNICAL FIELD

The present invention relates to a lithium ion battery, wherein a laminated body of an electrode sheet and a separator impregnated with a nonaqueous electrolytic solution is sealed in an airtight container, and particularly relates to a lithium ion battery having a function of suppressing an increase of an internal pressure caused by gas components to be generated inside the battery, such as CO and CO₂. Also, the present invention relates to electronic devices using the lithium ion battery.

### BACKGROUND ART

In recent years, large-capacity and high-power output lithium ion batteries have been in practical use. These lithium ion batteries are required to secure higher safety and stability than in conventional secondary batteries because of the large capacity and high power output.

In this lithium ion battery, a positive electrode body and negative electrode body together with an electrolytic solution are sealed in an airtight container, lithium ions in the electrolytic solution contribute to electric conduction. The laminate body of electrode sheets and separator is formed to be in a sandwiched form when it is square and a rolled form when it is cylindrical. Lead parts of the positive body and negative body as collectors are connected to respective terminals. After housing the laminate body in various forms as above in an airtight container in corresponding shapes, an electrolytic solution is poured from an opening of the airtight container so as to impregnate the laminate body with the electrolytic solution, and a battery container is sealed in a state of exposing ends of the positive body and negative body to the outside, which is a general configuration.

As the electrolytic solution to be used for the lithium ion batteries as above, a nonaqueous electrolytic solution containing ethylene carbonate, etc. is used and particularly a carbonic ester-based electrolytic solution being chargeable/dischargeable at a high voltage is widely used since it is effective to heighten a usable voltage in order to improve an energy density of lithium ion batteries.

In a lithium ion battery using a nonaqueous electrolytic solution as such, a carbonic ester included in the nonaqueous electrolytic solution becomes deteriorated or causes electrolysis due to repetitive charging and discharging over a long period of time or an increase of temperature inside the battery at the time of abnormalities, such as overcharging and short circuiting. As a result, CO, CO₂ or other gas may be generated inside the battery and an increase of internal pressure may cause deformation of the airtight container, which may be liable to cause an increase of internal resistance or other trouble. Therefore, a variety of techniques of adsorbing or suppressing those gases have been proposed.

To adsorb or suppress such gases, the patent documents 1 to 3 disclose techniques of adding additives to reduce generation of gases in the electrolytic solution. Also, the patent document 4 proposes an electric double-layer capacitor configured to adsorb CO₂ with an adsorbent mainly comprising hydroxides, such as lithium hydroxide.

### PRIOR ART DOCUMENTS

### Patent Documents

[Patent Document 1] Japanese Patent Publication No. 2005-235591

[Patent Document 2] Japanese Patent Publication No. H06-267593

[Patent Document 3] Re-publication of PCT International Publication No. 2010/147236

[Patent Document 4] Japanese Patent Publication No. 2003-197487

### DISCLOSURE OF THE INVENTION

### Problems to be Solved by the Invention

The techniques of adding additives to the electrolytic solution described in the patent documents 1 to 3, however, have a problem that generation of gases, such as CO and CO₂, is not suppressed sufficiently. The technique described in the patent article 4 has the effect of adsorbing CO₂, etc. to a certain extent, however, also has a problem that adsorption of CO cannot be expected. Also, when a lithium hydroxide or other alkali hydroxide contacts with nonaqueous electrolytic solution, a hydroxide is dissolved in the nonaqueous electrolytic solution, which is a problem. Furthermore, when alkali hydroxide reacts with CO₂, water is generated, which may result in an increase of corrosiveness.

The present invention was made in consideration of the above circumstances and has an object thereof to provide a lithium ion battery having an effect of adsorbing gaseous components, such as CO and CO₂, generated inside the battery at the time of abnormalities or when used for a long period of time and having an excellent characteristic of maintaining the performance. Another object of the present invention is to provide electronic devices excellent in safety incorporating the lithium ion battery.

### Means to Solve the Problems

To solve the problems above, firstly, the present invention provides a lithium ion battery, wherein a laminate body of a positive electrode, negative electrode and separator impregnated with a nonaqueous electrolytic solution is sealed in an airtight container, lithium ions in the nonaqueous electrolytic solution carry out electric conduction, and a CO and CO₂ adsorbent is filled in the airtight container (Invention 1).

According to the invention (Invention 1), since the CO and CO₂ adsorbent adsorbs gaseous components, such as CO and CO₂, quickly at a high adsorption rate, it is possible to suppress a reduction of a battery capacity, deformation of the airtight container along with an increase of an internal pressure due to generation of those gaseous components in the lithium ion battery at abnormalities, and an increase of internal resistance of the battery.

In the invention above (Invention 1), the CO and

CO₂ adsorbent is preferably separated from the nonaqueous electrolytic solution by an electric insulation gas-liquid separation membrane (Invention 2).

According to the invention (Invention 2), as a result of separating gaseous components, such as CO and CO₂, generated in the lithium ion battery from the nonaqueous electrolytic solution by a gas-liquid separation membrane and arranging the CO and CO₂ adsorbent on the gaseous components side, the gaseous components, such as CO and CO₂, can be adsorbed selectively and a reduction of the nonaqueous electrolytic solution can be suppressed to the minimum. Furthermore, since the nonaqueous electrolytic solution does not contact directly with the CO and CO₂ adsorbent, the gas adsorption performance of the CO and CO₂ adsorbent can be maintained.

In the above inventions (Inventions 1 and 2), the CO and CO₂ adsorbent is preferably an organic-based material, inorganic-based material or organic-inorganic composite material (Invention 3).

According to the invention (Invention 3), since those CO and CO₂ adsorbents adsorb gaseous components, such as CO and CO₂, quickly at a high adsorption rate, it is possible to suppress deformation of the airtight container along with an increase of an internal pressure due to those gaseous components in the lithium ion battery at abnormalities and to suppress an increase of internal resistance in the battery.

In the inventions above (Inventions 1 to 3), preferably the CO and CO₂ adsorbent is an inorganic porous material, carbon-based material, organic host compound, porous organic metal composite material or basic material (Invention 4). Particularly, the CO and CO₂ adsorbent is preferably a zeolite (Invention 5).

According to the inventions (Inventions 4 and 5), those CO and CO₂ adsorbents adsorb gaseous components, such as CO and CO₂, quickly at a high adsorption rate, it is possible to suppress deformation of the airtight container along with an increase of an internal pressure due to those gaseous components in the lithium ion battery at abnormalities and to suppress an increase of internal resistance in the battery. Moreover, an amount of the CO and CO₂ adsorbent may be small, the lithium ion battery can be downsized.

In the inventions above, (Inventions 4 and 5), preferably the CO and CO₂ adsorbent has a specific surface area of 100 to 3000m²/g (Invention 6).

According to the invention (Invention 6), a contact area with the gaseous components, such as CO and CO₂, can be secured sufficiently, a high adsorption rate can be maintained.

In the inventions above (Inventions 4 to 6), preferably the CO and CO₂ adsorbent has a fine pore diameter of 3 Å to 10 Å (Invention 7).

According to the invention (Invention 7), the CO and CO₂ adsorbent is capable of trapping gaseous components, such as CO and CO₂, inside fine pores and adsorbing the gases quickly.

In the invention above (Invention 5), preferably the CO and CO₂ adsorbent is a zeolite having an element composition ratio of Si/Al being in a range of 1 to 5 (Invention 8), and an A zeolite, X zeolite or LSX zeolite may be used (Invention 9). Particularly, the CO and CO₂ adsorbent is preferably an LSX zeolite ion-exchanged with Li (Invention 10).

According to the inventions (Inventions 8 to 10), vapor and other decomposition gases, etc. of the electrolytic solution can be adsorbed quickly at a high adsorption rate.

In the inventions above (Inventions 5, 8 and 9), preferably the CO and CO₂ adsorbent is an A zeolite ion-exchanged with Ca (Invention 11).

According to the invention (Invention 11), when zeolites adsorb moisture, the CO and CO₂ adsorption performance declines widely, while an A zeolite ion-exchanged with Ca restores the CO and CO₂ adsorption performance widely when renewed by heat drying, etc. and durability thereof can be improved.

Secondly, the present invention provides an electronic device incorporating the lithium ion battery according to any of Inventions 1 to 11 (Invention 12).

According to the invention (Invention 12), it is possible to obtain an electronic device free from adverse effect caused by a lithium ion battery, wherein a reduction of capacity of the lithium ion battery is suppressed and an amount of gases, such as CO and CO₂, generated by decomposition of the nonaqueous electrolytic solution can be reduced so as to suppress deformation of the battery container.

### Effect of the Invention

According to the present invention, since the battery container of the lithium ion battery is filled with a CO and CO₂ adsorbent, it is possible to reduce CO and CO₂, generation amounts of which are large, among gases generated from the nonaqueous electrolytic solution used in the lithium ion battery, so that a lithium ion battery with a high maintenance rate of the performance can be obtained.

### BRIEF DESCRIPTION OF DRAWINGS

FIG. 1 A sectional view schematically showing the inside configuration of a nonaqueous electrolytic solution lithium ion battery according to an embodiment of the present invention.

### MODE(S) FOR CARRYING OUT THE INVENTION

Below, an embodiment of the present invention will be explained in detail with reference to the attached drawing. Note that the embodiment is to show examples and the present invention is not limited to them.

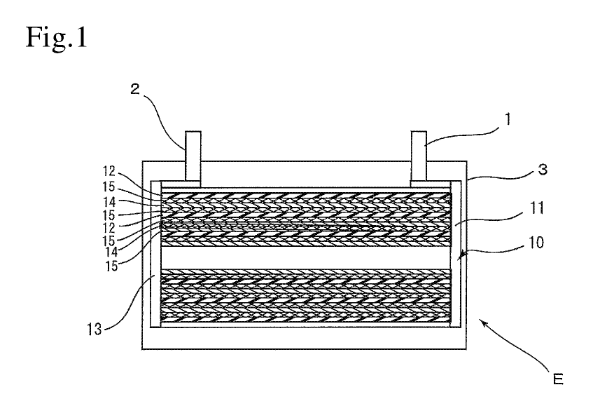

FIG. 1 is a vertical sectional view showing a lithium ion battery of the present embodiment. In FIG. 1, a lithium ion battery E comprises a positive electrode terminal 1 and negative electrode terminal 2, a battery case (chases) 3 being an airtight container, and an explosion-proof valve (not illustrated) formed on an outer circumferential surface of the battery case 3 as needed, wherein an electrode body 10 is housed inside the battery case 3. The electrode body 10 comprises a positive electrode collector 11 and electrode plate 12 for positive electrodes, a negative electrode collector 13 and electrode plate 14 for negative electrodes, wherein the electrode plate 12 for positive electrodes and the electrode plate 14 for negative electrodes have a laminate configuration of sandwiching a separator 15 therebetween. The positive electrode terminal 1 is electrically connected to the electrode plate 12 for positive electrodes and the negative electrode terminal 2 to the electrode plate 14 for negative electrodes. The battery case 3 as the chasses is, for example, a square-shaped battery case can made of aluminum or stainless steel and has airtightness.

The electrode plate 12 for positive electrodes is a collector wherein a positive electrode mixture is held on both surfaces. For example, the collector may be an aluminum foil having a thickness of about 20 μm and a positive electrode mixture paste is obtained by lithium cobalt oxide (LiCoO₂) as a transition metal lithium-containing oxide added with polyvinylidene fluoride as a binding material and acetylene black as a conductive material, and kneading. The electrode plate 12 for positive electrodes is obtained by the process of applying the positive electrode mixture paste on both surfaces of an aluminum foil, drying, rolling and cutting into a strip shape.

The electrode plate 14 for negative electrodes is a collector, wherein a negative electrode mixture is held on both surfaces. For example, the collector is a copper foil having a thickness of 10 μm and the negative electrode mixture paste is obtained by adding polyvinylidene fluoride as a binding material to a graphite powder and, then, kneading. The electrode plate 14 for negative electrodes is obtained by the process of applying the negative electrode mixture paste on both surfaces of the copper foil, drying, rolling and cutting into a strip shape.

A porous film is used as the separator 15. For example, a polyethylene fine porous film may be used as the separator 15. As the nonaqueous electrolytic solution to be impregnated in the separator, a nonaqueous organic electrolytic solution having lithium ion conductivity is preferable and, for example, a mixed solution of propylene carbonate (PC), ethylene carbonate (EC) or other cyclic carbonate and dimethyl carbonate (DMC), ethylmethyl carbonate (EMC), diethyl carbonate (DEC) or other chain carbonate is preferable and, in accordance with need, lithium hexafluorophosphate or other lithium salt is dissolved as electrolyte. For example, a mixed solution of ethylene carbonate (EC), ethylmethyl carbonate (EMC) and dimethyl carbonate (DMC) mixed at a ratio of 1:1:1 or a mixed solution of propylene carbonate (PC), ethylene carbonate (EC) and diethyl carbonate (DEC) mixed at a ratio of 1:1:1 added with 1 mol/L of lithium hexafluorophosphate may be used.

The CO and CO₂ adsorbent is arranged in a gap part in the battery case (chasses) of a lithium ion battery E as above. In the present embodiment, the CO and CO₂ adsorbent may be any if it has a function of adsorbing CO and/or CO₂ generated by decomposition of the electrolytic solution and may be effective only to either one of the specified gas. Also, those which physically adsorb gaseous components, such as CO and CO₂, and those which utilize an intermolecular interaction or the effect of spaces in crystalline lattice so as to include gaseous components, such as CO and CO₂, therein may be used.

As specific examples of the CO and CO₂ adsorbent used in the present embodiment, inorganic porous materials or other inorganic-based materials, carbon-based materials, organic host compounds, porous organometallic composite materials and other organic-based materials may be mentioned.

As an inorganic porous material, porous silica, metal porous structure, calcium silicate, magnesium silicate, magnesium aluminometasilicate, zeolite, activated alumina, titanium oxide, apatite, porous glass, magnesium oxide and aluminum silicate, etc. are preferable.

As a carbon-based material, granular activated carbon, fibrous activated carbon, sheet-shaped activated carbon, graphite, carbon nanotube, fullerene and nano carbon, etc. are preferable.

As an organic host compound, a-cyclodextrin, p-cyclodextrin, y-cyclodextrin, calyx allenes, urea, deoxycholic acid, cholic acid, 1,1,6,6-tetraphenylhexa-2,4-diyne-1,6-diol and other acetylene alcohols, 1,1-bis(4-hydroxyphenyl)cyclohexane and other bisphenols, 1,1,2,2-tetrakis(4-hydroxyphenyl)ethane and other tetrakisphenols, bis-3-naphthol and other naphthols, diphenic acid bis(dicyclohexylamide) and other carboxylic acid amides, 2,5-di-t-butylhydroquinone and other hydroquinones, chitinase, chitosan, etc. are preferable.

These organic host compounds may be used alone or in combination of two or more kinds. Also, the organic host compound may be used as an organic-inorganic composite material carried on an inorganic-based porous material. In that case, as the porous material to carry the organic host compound, clay minerals, montmorillonites and other interlayer compounds, etc. may be mentioned besides silicas, zeolites and activated carbons. However, it is not limited to those.

As a porous organometallic complex, a porous organometallic complex compound called Metal-Organic Frameworks (MOF), organic carboxylate salt, organic boron compound, organic phosphorous compound, organic aluminum compound, organic titanium compound, organic silica compound, organic zinc compound, organic magnesium compound, organic indium compound, organic tin compound, organic tellurium compound and organic gallium compound, etc. are preferable.

Those CO and CO₂ adsorbents may be used alone or in combination of two or more kinds, but zeolites are particularly preferable.

The CO and CO₂ adsorbents mentioned above preferably have a specific surface area of 100 to 3000 m²/g. When the specific surface area is less than 100 m²/g, a contact area with CO, CO₂ or other gaseous components becomes small and a sufficient adsorption performance cannot be brought out. On the other hand, when the specific surface area exceeds 3000 m²/g, not only the effect of improving the adsorption performance of CO and CO₂ cannot be obtained, but mechanical strength of the CO and CO₂ adsorbent is deteriorated, which is not preferable.

Also, the CO and CO₂ adsorbents preferably have a fine pore diameter of 3 Å or more and 10 Å or less. When the fine pore diameter is less than 3 Å, intrusion to inside the fine pores by CO, CO₂ or other gaseous components becomes difficult. On the other hand, when the fine pore diameter excess 10 Å, adsorption strength to CO and CO₂ declines and closest-packed adsorption cannot be attained in the fine pores, consequently, the adsorption quantity is reduced, which is not preferable.

Furthermore, when the CO and CO₂ adsorbent is a zeolite, those having an element composition ratio of Si/Al in a range of 1 to 5 are used preferably. Zeolites with a Si/Al ratio being less than 1 are structurally unstable, while zeolites with a Si/Al ratio exceeding 5 have a low cation content and a CO and CO₂ adsorption quantity is reduced, which is not preferable.

It is preferable to use an A zeolite, X zeolite or LSX zeolite. Particularly, an LSX or A zeolite, wherein a cation part is ion-exchanged with Li, or an A zeolite, wherein a cation part is ion-exchanged with Ca, are preferable. An A zeolite ion-exchanged with Ca is more preferable.

A CO and CO₂ adsorbent housed in the battery case 3 possibly adsorbs moisture due to humidity in an atmosphere at a stage of assembling the lithium ion battery. There is a problem that, when a zeolite adsorbs moisture, the performance of adsorbing CO and CO₂ declines widely and the CO and CO₂ adsorption performance is hard to be restored completely even if it is renewed by heat drying. However, an A zeolite ion-exchanged with Ca is capable of restoring the adsorption performance by getting rid of moisture by heating after adsorbing the moisture, so that it is suitable to provide lithium ion batteries with improved durability.

In the case of making CO₂ adsorbed mainly, a basic material having a function of adsorbing CO₂ neutrally may be used, as well. As the basic material, specifically, potassium carbonate, sodium carbonate and other metal carbonates; sodium hydrogen carbonate, magnesium hydrogen carbonate, calcium hydrogen carbonate and other metal hydrogen carbonates; magnesium hydroxide, sodium hydroxide, calcium hydroxide and other alkali hydroxides; other alkali minerals, organics and porous materials, etc. may be mentioned.

A shape of the CO and CO₂ adsorbent in the present embodiment as explained above is not particularly limited and any shape may be applied, such as powder, granular, block and tablet shapes. However, in consideration of handleability, those molded in a range of not affecting the gas adsorption performance are preferably used.

Also, for the purpose of suppressing a decline of the performance of a gas adsorbent due to moisture, water adsorbing material may be blended in an amount of 25 to 75 volume % or so with respect to 100 volume % of CO and CO₂ adsorbent. As the water adsorption material, a molecular sieve and other zeolites, silica gel, activated alumina, calcium chloride and diphosphorus pentoxide, etc. may be used, however, a molecular sieve is preferable because it is porous and exhibits a large adsorption quantity.

It is preferable that the CO and CO₂ adsorbent is arranged to be separate from a gas-liquid separation membrane so that a nonaqueous electrolytic solution does not directly contact with the CO and CO₂ adsorbent rather than to be filled as it is in the battery case (chases) 3. As a result of separating the nonaqueous electrolytic solution from the CO and CO₂ adsorbent by the gas-liquid separation membrane, CO, CO₂ and other gaseous components generated from the lithium ion battery can permeate the gas-liquid separation membrane, but the nonaqueous electrolytic solution in liquid state does not permeate, therefore, CO, CO₂ and other gaseous components can be selectively adsorbed and a reduction of the nonaqueous electrolytic solution can be suppressed to the minimum.

An explanation will be made on the effects of a lithium ion battery configured as above. When a lithium ion battery is used for a long period of time, the nonaqueous electrolytic solution included in the lithium ion battery is decomposed to generate gaseous components, such as CO and CO₂. Those CO, CO₂ and other gaseous components are liable to cause an increase of an internal pressure of the battery case (chasses) 3, however, in the present embodiment, the CO and CO₂ adsorbent is provided in the battery case (chasses) 3 to adsorb CO and CO₂, so that the internal pressure of the battery case (chases) 3 does not rise excessively. Thereby, the lithium ion battery can attain improved safety and long durability.

The present invention was explained above with reference to the attached drawing, however, the present invention is not limited to the embodiment above and can be modified variously. For example, the lithium ion battery E may be cylindrical-shaped and, furthermore, the lithium ion battery may be housed in a battery case capable of housing it and the gas adsorbent may be provided in the battery case.

### EXAMPLES

Below, the present invention will be explained further in detail based on specific examples, however, the present invention is not limited to the examples below.

### Example 1

An LSX zeolite ion-exchanged with Li was used as the CO and CO₂ adsorbent and the nitrogen adsorption method was used to measure an equilibrium adsorption quantity of CO₂ and CO at 25° C. and 760 mmHg. The result was that the CO₂ adsorption quantity was 130 mL/g and the CO adsorption quantity was 52 mL/g.

### Example 2

An X zeolite ion-exchanged with Ca was used as the CO and CO₂ adsorbent and the nitrogen adsorption method was used to measure an equilibrium adsorption quantity of CO₂ and CO at 25° C. and 760 mmHg. The result was that the CO₂ adsorption quantity was 130 mL/g and the CO adsorption quantity was 38 mL/g.

### Example 3

An X zeolite ion-exchanged with Na was used as the CO and CO₂ adsorbent and the nitrogen adsorption method was used to measure an equilibrium adsorption quantity of CO₂ and CO at 25° C. and 760 mmHg. The result was that the CO₂ adsorption quantity was 132 mL/g and the CO adsorption quantity was 27 mL/g.

### Example 4

An A zeolite ion-exchanged with Ca was used as the CO and CO₂ adsorbent and the nitrogen adsorption method was used to measure an equilibrium adsorption quantity of CO₂ and CO at 25° C. and 760 mmHg. The result was that the CO₂ adsorption quantity was 105 mL/g and the CO adsorption quantity was 31 mL/g.

### Example 5

An A zeolite ion-exchanged with Na was used as the CO and CO₂ adsorbent and the nitrogen adsorption method was used to measure an equilibrium adsorption quantity of CO₂ and CO at 25° C. and 760 mmHg. The result was that the CO₂ adsorption quantity was 70 mL/g and the CO adsorption quantity was 19 mL/g.

### Example 6

A Y zeolite ion-exchanged with H was used as the CO and CO₂ adsorbent and the nitrogen adsorption method was used to measure an equilibrium adsorption quantity of CO₂ and CO at 25° C. and 760 mmHg. The result was that the CO₂ adsorption quantity was 15 mL/g and the CO adsorption quantity was 2 mL/g.

### Example 7

An ZSM-5 zeolite ion-exchanged with Ca was used as the CO and CO₂ adsorbent and the nitrogen adsorption method was used to measure an equilibrium adsorption quantity of CO₂ and CO at 25° C. and 760 mmHg. The result was that the CO₂ adsorption quantity was 56 mL/g and the CO adsorption quantity was 10 mL/g.

As is clear from the examples 1 to 5 above, when using an LSX, X or A zeolite, it is shown that larger quantities of CO and CO2 can be adsorbed than in examples 6 and 7.

### Examples 8 to 12

(Test of Reactivity with Electrolytic Solution)

In the lithium ion battery of the preset invention, since a CO and CO₂ adsorbent is to be placed inside a battery case, those which react with an electrolytic solution to generate gas or heat are not preferable. Therefore, tests of reactivity of a variety of zeolites with an electrolytic solution were performed by the following process. As the electrolytic solution, a mixed liquid was prepared by mixing propylene carbonate (PC) ethylene carbonate (EC) and diethyl carbonate (DEC) at a ratio of 1:1:1.

A Sample (a variety of zeolites shown in Table 1) in an amount of 5 g was put in a 50 mL-gas collecting bottle in a dry nitrogen atmosphere, a vacuum pump was connected, discharging was performed for three minutes and then sealed in the pressure reduced state. Next, in a dry nitrogen atmosphere, 10 mL of the electrolytic solution was added from a septum cap of the gas collecting bottle by using a syringe and whether heat and bubbles were generated or not was confirmed. Furthermore, after storing for 18 hours in a dry nitrogen atmosphere, the gas collecting bottle was opened in a dry nitrogen atmosphere, the gas inside the gas collecting bottle was analyzed by a gas chromatograph (GC), and whether dioxide and ethylene were generated or not was confirmed. The results are shown in Table 1.

The results of measuring adsorption quantities of CO₂ at 25° C. and 760 mmHg in respective samples of examples 8 to 12 are also shown in Table 1. Note that the adsorption quantity of CO₂ was measured by the reduced pressure test method below.
(1) Used Tools
   (a) vacuum desiccator (volume: 1.37 L)
   (b) vacuum pump
   (c) vacuum container (having the same volume as the vacuum desiccator and provided with a pressure gauge)
   (d) pressure sensor (capable of displaying reduced pressure and attached to the (a) vacuum desiccator)
   (e) data logger
   (f) petri dish (made of metal)
   (g) CO₂ gas
   (h) electronic balance
(2) Measurement Operation

First, each sample in an amount of about 5 g was taken, the accurate weight was measured with an electronic balance and allocated to a petri dish in a nitrogen-purged globe box. The allocated sample was taken in a desiccator quickly, a lid was put on the petri dish and a vacuum pump was used to reduce the pressure to a gauge pressure of 100 kPa. On the other hand, inside the pressure container was replaced completely with a CO₂ gas and filled until the gauge pressure reaches 100 kPa. Recording with a data logger at the desiccator started at this point. Subsequently, the vacuum desiccator and the pressure container were connected so as to feed the CO₂ gas to the vacuum desiccator until the gauge of the pressure container hits 0 kPa, and this point was marked as adsorption start time. Then, a value on the data logger after a certain time was taken to calculate an adsorption quantity of a CO₂ gas.

Here, as to a CO₂ gas adsorption quantity, to consider the case where a half of the CO₂ gas was adsorbed when the 1.37 L container had been filled with the CO₂ gas, it is considered that 685 mL of the CO₂ gas was adsorbed. In that case, the pressure would be halved, so that a value on the pressure sensor would be in the middle of vacuum and the atmospheric pressure (101.3/2 kPa), that is 50.56 kPa. Consequently, when a CO₂ gas adsorption quantity is indicated as “y” (mL) and a value on the pressure sensor is “x” (kPa), the formula (1) below is derived.

y=−13.62x (1)

Therefore, calculations were based on this formula.

TABLE 1

| | | CO₂ | | | | |
|---|---|---|---|---|---|---|
| | | Adsorption | | | | |
| | Kind of | Quantity | Heat | Bubble | GC | |
| Example No. | Zeolite | (mL/g) | Generation | Generation | Analysis | Evaluation |
| Example 8 | A Zeolite | 80 | No | No | — | ∘ |
| | ion-exchanged | | | | | |
| | with Ca | | | | | |
| Example 9 | X Zeolite | 90 | Yes | Yes | CO₂ | x |
| | ion-exchanged | | | | C₂H₄ | |
| | with Ca | | | | | |
| Example 10 | A Zeolite | 77 | No | No | — | ∘ |
| | ion-exchanged | | | | | |
| | with Li | | | | | |
| Example 11 | X Zeolite | 104 | Yes | Yes | CO₂ | x |
| | ion-exchanged | | | | C₂H₄ | |
| | with Na | | | | | |
| Example 12 | LSX Zeolite | 81 | yes | yes | CO₂ | x |
| | ion-exchanged | | | | C₂H₄ | |
| | with Li | | | | | |

As is clear from Table 1, the example 8 (A zeolite ion-exchanged with Ca) and the example 10 (A zeolite ion-exchanged with Li) exhibited excellent carbon dioxide adsorption performance and poor reactivity with the electrolytic solution. On the other hand, the zeolites in examples 9, 11 and 12 exhibited excellent carbon dioxide adsorption performance but reacted with the electrolytic solution to generate heat, babbles and gases, etc. From those results, an A zeolite ion-exchanged with Ca and A zeolite ion-exchanged with Li were revealed to be preferable for lithium ion batteries.

### Examples 13 and 14

(Test for Confirming Renewal Characteristic after Moisture Adsorption)

The A zeolite ion-exchanged with Ca (example 13) and A zeolite ion-exchanged with Li (example 14), which exhibited preferable results among the examples 8 to 12 above, were used as samples, each placed to have a thickness of 5 mm or so on a stainless-steel vat and a weight thereof was measured accurately. The samples were left and humidified in a thermostatic chamber at 25° C. and 50% RH for 12 hours or more until the weight of each sample was confirmed to be increased by 10% or more. Adsorption quantities of CO2 gas at this time were measured in the same way as in the examples 8 to 12 and shown in Table 2 together with initial adsorption quantities of respective samples measured in advance.

Note that an increase of 10% or more of the sample weights means that 20 wt % of moisture is included therein.

Next, those samples were fed to a nitrogen-purged (10L per minute) electric furnace, heated at 300° C. for 1 hour to dry, taken out and then cooled to the normal temperature in a nitrogen-purged glove box, so that the samples were renewed. Adsorption quantities of CO₂ gas of those renewed samples were measured in the same way as in the examples 8 to 12 above and the results are shown in Table 2.

TABLE 2

| | CO₂ Adsorption Quantity (mL/g) | | |
|---|---|---|---|
| Example No. | Initial Stage | After Humidification | After Renewal |
| Example 13 | 88 | 0 | 88 |
| Example 14 | 59 | 0 | 28 |

As is clear from Table 2, the example 13, wherein an A zeolite ion-exchanged with Ca was used, exhibited a higher CO₂ adsorption quantity initially comparing with that in the example 14, wherein an A zeolite ion-exchanged with Li was used, and it was almost restored after renewing. On the other hand, the example 14 restored the CO₂ adsorption performance only slightly after renewal. Also, it is shown that the CO₂ adsorption performance of the zeolite was lost almost completely due to humidification. Based on the above, it is confirmed that when focusing on the renewing performance after humidification, an A zeolite ion-exchanged with Ca is preferable.

### INDUSTRIAL APPLICABILITY

As explained above, since the lithium ion battery of the present invention comprises a gas adsorbent capable of adsorbing CO₂ and CO generated inside the battery and reducing their volume, safety of the lithium ion battery can be improved widely and the applicability in the industry is extremely high. Also, electronic devices incorporating such lithium ion batteries are excellent in safety.

### EXPLANATION OF NUMERICAL REFERENCES

1 . . . positive electrode terminal (positive electrode)
2 . . . negative electrode terminal (negative electrode)
3 . . . battery case (chassis) (airtight container)
11 . . . positive electrode collector (positive electrode)
13 . . . negative electrode collector (negative electrode)
E . . . lithium ion battery

1. A lithium ion battery, wherein a laminate body of a positive electrode, negative electrode and separator impregnated with a nonaqueous electrolytic solution is sealed in an airtight container, lithium ions in the nonaqueous electrolytic solution carry out electric conduction, and a CO and CO₂ adsorbent is filled in the airtight container.

2. The lithium ion battery according to claim 1, wherein the CO and CO₂ adsorbent is separated from the nonaqueous electrolytic solution by an electric insulation gas-liquid separation membrane.

3. The lithium ion battery according to claim 1, wherein the CO and CO₂ adsorbent is an organic-based material, inorganic-based material or organic-inorganic composite material.

4. The lithium ion battery according to claim 1, wherein the CO and CO₂ adsorbent is an inorganic porous material, carbon-based material, organic host compound, porous organic metal composite material or basic material.

5. The lithium ion battery according to claim 1, wherein the CO and CO₂ adsorbent is a zeolite.

6. The lithium ion battery according to claim 4, wherein the CO and CO₂ adsorbent has a specific surface area of 100 to 3000 m²/g.

7. The lithium ion battery according to claim 4, wherein the CO and CO₂ adsorbent has a fine pore diameter of 3 Å to 10 Å.

8. The lithium ion battery according to claim 5, wherein the CO and CO₂ adsorbent is a zeolite having an element composition ratio of Si/Al being in a range of 1 to 5.

9. The lithium ion battery according to claim 5, wherein the CO and CO₂ adsorbent is an A zeolite, X zeolite or LSX zeolite.

10. The lithium ion battery according to claim 5, wherein the CO and CO₂ adsorbent is an LSX zeolite ion-exchanged with Li.

11. The lithium ion battery according to claim 5, wherein the CO and CO₂ adsorbent is an A zeolite ion-exchanged with Ca.

12. An electronic device, wherein the lithium ion battery according to claim 1 is incorporated.
